(19) United States
(12) Patent Application Publication
(10) Pub. No.: US 2019/0283184 A1
(43) Pub. Date: Sep. 19, 2019

(54) LASER SHOCK FORGING AND LASER CUTTING COMPOSITE ADDITIVE MANUFACTURING DEVICE AND METHOD

(71) Applicant: GUANGDONG UNIVERSITY OF TECHNOLOGY, GUANGZHOU (CN)

(72) Inventors: Yongkang ZHANG, GUANGZHOU (CN); Qiuyun YU, GUANGZHOU (CN); Qingtian YANG, GUANGZHOU (CN); Fenghuai YANG, GUANGZHOU (CN); Zhifan YANG, GUANGZHOU (CN)

(21) Appl. No.: 16/432,828

(22) Filed: Jun. 5, 2019

Related U.S. Application Data
(63) Continuation of application No. PCT/CN2018/102601, filed on Aug. 28, 2018.

(30) Foreign Application Priority Data
Dec. 20, 2017 (CN) 201711384816.9

(51) Int. Cl. B23K 26/342; B33Y 30/00; B33Y 40/00; B33Y 50/00; B33Y 10/00; B23K 26/00; B23K 26/06; B23K 26/064; B23K 26/067; B23K 26/08; B23K 26/14; B23K 26/356; B23K 26/38; B23K 31/00; B23K 31/10; B23K 31/12

(52) U.S. Cl. CPC B23K 26/342; B23K 31/125; B33Y 40/00; B33Y 50/00; B33Y 10/00; B23K 26/00; B23K 26/0626; B23K 26/064; B23K 26/0673; B23K 26/08; B23K 26/1464; B23K 26/356; B23K 26/38; B23K 31/003; B23K 31/10; B33Y 30/00

(57) ABSTRACT

The present invention discloses a laser shock forging and laser cutting composite additive manufacturing device and method. The device forms two different light guide systems by splitting an output laser beam of a laser device into two laser beams through a beam splitter system. The first light guide system splits a laser beam into a third laser beam and a fourth laser beam which are respectively applied to laser 3D (3-Dimensional) printing and laser cutting. The second laser beam is applied to laser shock forging. A three dimensional model is built according to individual design requirements of a part. Layer-by-layer slicing treatment is performed to acquire slice contour information, so as to determine a layered contour and internal complex structures such as a cavity, a pipeline and a cold pipe of the part through laser cutting. The third laser beam forms an Nth layer of slice through 3D printing, and the second laser beam performs synchronous laser shock forging in an optimal temperature region. The fourth laser beam works when the thickness of each layer of slice or each slice layer meets the requirements, thereby guaranteeing the dimension accuracy and the surface quality and realizing high-rigidity, high-accuracy and high-efficiency 3D printing. The device has the advantages of high machining efficiency, high quality and long service life.

### CROSS-REFERENCE TO RELATED APPLICATIONS

This application is a continuation of International Patent Application No. PCT/CN2018/102601 with a filing date of Aug. 28, 2018, designating the United States, now pending, and further claims priority to Chinese Patent Application No. 201711384816.9 with a filing date of Dec. 20, 2017. The content of the aforementioned applications, including any intervening amendments thereto, are incorporated herein by reference.

### TECHNICAL FIELD

The present invention relates to the technical field of additive manufacturing, and more particularly relates to a laser shock forging and laser cutting composite additive manufacturing device and method.

### BACKGROUND OF THE PRESENT INVENTION

A 3D (3-Dimensional) printing technology may quickly process parts that are difficult to manufacture by traditional methods, and has great advantages for complex parts. However, 3D printers are still actually used in the field of rapid prototyping. According to the statistics, 80% of products produced by 3D printing are still product prototypes, and only 20% of the products are final products. At present, a contradiction between the printing efficiency and the machining accuracy is the main problem. To achieve high-accuracy printing quality, a relatively thin slice is required, which leads to very low printing efficiency. Improving the printing efficiency makes the printing accuracy and surface smoothness relatively low and requires subsequent surface treatment. In addition, an inner cavity of a 3D printed object having a complicated structure is difficult to further treat after printing is completed, so the surface quality thereof is difficult to guarantee. At present, these existing defects severely limit practical applications of 3D printing.

According to the Chinese patent CN104493492A: selective laser melting and milling composite machining equipment and machining method, a vertical milling machining device is disposed on the inner side of a sealed molding chamber; the equipment adopts a light path transmission system; a molding range is divided into four stations; the system works cooperatively; and each light path unit melts metal powder in one station. After scanning a plurality of layers of metal powder, the equipment turns to milling to precisely cut layered contours and internal holes of parts at high speed, and cuts off protrusions of a molded surface, so as to improve the powder laying quality of the next laser forming. The equipment has the following problems that: (1) the milling forming range of the equipment that moves along a fixed guide rail is limited, so large-size complex metal parts are difficult to machine; (2) a final surface of an SLM (Selective Laser Melting) formed part may have many rugged stripes and has a general surface roughness of Ra 15 to 50 um, and if light spots are larger, the forming accuracy is lower, so it is very hard to guarantee both the high efficiency and the high accuracy of large-size parts; (3) large-size complex curved surface parts need to be secondarily machined, so that a tool replacement mechanism is still needed to replace an additive manufacturing module and a subtractive manufacturing module; and (4) when a milling cutter is used to mill large-size complex metal parts, small plastic deformation is caused, so it is very hard to eliminate internal defects such as holes, shrinkage and micro cracks in a cladding layer.

Therefore, the prior art needs to be further improved and perfected.

### SUMMARY OF PRESENT INVENTION

The purpose of the present invention is to overcome the shortcomings in the prior art, so as to provide a laser shock forging and laser cutting composite additive manufacturing device with high machining efficiency and high quality.

Another purpose of the present invention is to overcome the shortcomings in the prior art, so as to provide a manufacturing method based on the above-mentioned device.

The purposes of the present invention are realized through the following technical solution:

A laser shock forging and laser cutting composite additive manufacturing device includes a laser generating system used for generating and controlling a laser beam, a laser shock forging system, a 3D (3-Dimensional) printing system, a laser cutting system, an on-line monitoring system used for monitoring internal structure performance, surface performance, shape and dimension of a part, and a real-time tracking and feedback system used for feeding back data to a plurality of laser beam power adjustment devices. The laser generating system is respectively connected with the laser shock forging system, the 3D printing system, the laser cutting system and the real-time tracking and feedback system. The on-line monitoring system is connected with the real-time tracking and feedback system.

Specifically, the laser generating system includes a computer, a laser device, a laser device power adjustment device, a beam splitter for splitting the laser beam into a first laser beam and a second laser beam, a first light guide system for controlling the first laser beam, a first power adjustment device and an adjustable beam splitter for splitting the first laser beam into a third laser beam and a fourth laser beam. The computer, the laser device power adjustment device, the laser device and the beam splitter are connected in sequence. One end of the first power adjustment device is connected with the first light guide system, and the other end of the first power adjustment device is connected with the adjustable beam splitter.

Specifically, the laser shock forging system includes a second light guide system for controlling the second laser beam, a laser shock forging power adjustment device, a laser shock forging laser head and a laser shock forging control system. The second light guide system, the laser shock forging power adjustment device, the laser shock forging control system and the laser shock forging laser head are connected in sequence. The second light guide system is connected with the beam splitter.

Specifically, the laser cutting system includes a fourth light guide system for controlling the fourth laser beam, a laser cutting power adjustment device, a laser cutting laser head and a laser cutting control system. The fourth light guide system, the laser cutting power adjustment device, the laser cutting control system and the laser cutting laser head are connected in sequence. The fourth light guide system is connected with the adjustable beam splitter.

Specifically, the 3D printing system includes a third light guide system for controlling the third laser beam, a 3D printing power adjustment device, a 3D printing head, a powder feeding system, a powder feeding head for coaxially conveying light and powder and a 3D printing control system. The third light guide system, the 3D printing power adjustment device, the 3D printing control system and the 3D printing head are connected in sequence. The powder feeding head is mounted on the 3D printing head and is connected with the computer through the powder feeding system. The third light guide system is connected with the beam splitter.

Specifically, the real-time tracking and feedback system is respectively connected with the computer, the laser power adjustment device, the first power adjustment device, the laser shock forging power adjustment device, the laser cutting power adjustment device and the 3D printing power adjustment device.

As a preferred solution of the present invention, the laser cutting laser head and the 3D printing head are disposed adjacently and in parallel. The adjustable beam splitter respectively controls the laser cutting laser head and the 3D printing head to work simultaneously or independently. Specifically, the laser device simultaneously supplies energy to the laser cutting laser head, the 3D printing head and the shock forging laser head. The laser cutting laser head and the 3D printing head are disposed adjacently and in parallel. The laser emission end of the laser device is connected with the beam splitter to split one laser beam into the first laser beam and the second laser beam. The first light guide system splits the first laser beam into the third laser beam and the fourth laser beam through the adjustable beam splitter for 3D printing and laser cutting. The adjustable beam splitter enables the laser cutting laser head and the 3D printing head to simultaneously or independently work to realize function integration of the laser cutting and the 3D printing, thereby making the power of each path of laser adjustable, reducing the quantity of laser devices, reducing the cost of the equipment and improving the compactness of the equipment.

As a preferred solution of the present invention, the laser shock forging system is disposed on the same side with the laser cutting laser head and the 3D printing head or on the side opposite to the laser cutting laser head and the 3D printing head, and the laser shock forging system may freely move on a working table. Specifically, the second light guide system, the laser shock forging power adjustment device, the laser shock forging control system and the laser shock forging laser head may freely move on both sides of the working table. That is, by maintaining the laser device fixed, the whole laser shock forging system moves to work on both sides or the same side of a part. The 3D printing system and the laser shock forging system are distributed on the same side to achieve a synchronous coupling action together with the on-line monitoring system. Laser shock forging refines crystalline grains on a cladding layer, thereby eliminating internal defects such as pores in the cladding layer, and a thermal stress, significantly improving the internal quality and comprehensive mechanical properties of a metal part and effectively controlling macroscopical deformation and cracking problems. The 3D printing system and the laser shock forging system are symmetrically distributed at corresponding portions of both sides of a blade along a center line. The on-line monitoring system and the 3D printing system are distributed in a certain spacing, and also may independently rotate to the laser shock forging side to achieve a synchronization action among the on-line monitoring system, the 3D printing system and the laser shock forging system. Superposed shock waves counteract an internal stress, thereby eliminating the internal defects such as the pores, significantly improving the internal quality and the comprehensive mechanical properties of the metal part and greatly improving the efficiency. An optimal working solution is selected through error analysis, which is beneficial to improving the machining efficiency.

As a preferred solution of the present invention, the laser cutting system may act on one or more slice layers. The laser cutting system designed in the present invention has no requirement for the thickness of a slice layer. An optimal number of layers of laser cutting may be determined for different functional requirements, different structures, different regions and different manufacturing processes according to individualized design requirements. Complex structures having cavities, pipelines, cold pipes and other internal configurations are subjected to laser cutting to obtain slice layers. The shapes are accurately controlled according to an individual design model without technological processes such as post-treatment. The synchronization action on each layer of slice may eliminate the internal defects such as internal residual stress, pores and cracks and eliminate defects such as stress superposition caused by superposition of multiple layers of slices. During laser cutting of multiple slice layers in a non-individual region, macroscopical deformations such as the shape and the dimension may be strictly controlled; the acting force between the slice layers and the internal defects may be reduced; and secondary machining such as the post-treatment may be avoided to guarantee the machining quality and improve the efficiency.

The other purpose of the present invention is realized through the following technical solution:

A laser shock forging and laser cutting composite additive manufacturing method is provided. The manufacturing method includes the following specific steps:

Step S1: inputting original data: designing a three-dimensional model of a part to be formed according to individual design requirements, performing layer-by-layer slicing treatment to determine an optimal number of layers suitable for laser cutting, calculating main process parameters of 3D printing and optimizing the parameters, estimating main process parameters of laser shock forging and optimizing the parameters, and determining an optimal temperature region for the laser shock forging; transmitting relevant data into a computer as the original data which are used as an adjustment control standard for relevant parameters of a laser shock forging and laser cutting composite additive manufacturing process;

Step S2: performing error analysis: forming a first layer of slice through laser 3D printing and synchronously, performing synchronous laser shock forging in the optimal temperature region; when the Nth layer of slice is obtained, performing laser cutting on the part to obtain a layered contour and internal complex structures; monitoring, by an on-line monitoring system, whether the internal structure performance, surface performance, shape and dimension of the part meet desirable requirements or not, comparatively analyzing the original data in Step 1 to determine whether the relevant process parameters are correct or not, and performing the error analysis to automatically compensate the process parameters and determine final optimal process parameters;

Step S3: automatically compensating the Nth layer of slice formed by synchronous shock forging and 3D printing on the same side: installing a 3D printing system and a laser shock forging system on the same side of a working table; printing, by the 3D printing system, the Nth layer of slice according to the individual design requirements for internal configurations such as a cavity, a pipeline and a cold pipe of the part to be formed; simultaneously, monitoring the internal structure performance, surface performance, shape and dimension of the formed slice layer in real time and on line; feeding back, by a real-time feedback system, data parameters to the 3D printing system and the laser shock forging system in sequence to automatically compensate the relevant process parameters; meanwhile, controlling, by a second laser beam control system, the laser shock forging system to work synchronously to realize a synchronous coupling action of 3D printing-detection and feedback-laser shock forging;

Step 4: performing data acquisition and error analysis after the synchronous coupling action of 3D printing-detection and feedback-laser shock forging is realized on the same side: acquiring, by the on-line monitoring system, parameters of the internal structure performance, surface performance, shape and dimension of the part to be formed and parameters of four laser beams of a laser device; storing, by a computer, the data and feeding back the data to a 3D printing power adjustment device and a laser shock forging power adjustment device, and performing the error analysis; analytically calculating an optimal thickness N of the slice formed on the same side, and determining whether the thickness of the slice formed on both sides meets the requirement or not;

Step S5: if the synchronous coupling action of 3D printing-detection and feedback-laser shock forging, realized on the same side, meets the relevant requirements, and an error is within an allowable error range, enabling a laser cutting system to work to cut, with laser, the internal configurations such as the cavity, the pipeline and the cold pipe of the part to be formed according to the individual design requirements, or implementing Step S6;

Step S6: automatically compensating the (N+1)th layer of slice formed by synchronous shock forging and 3D printing on both sides: distributing the 3D printing system and the laser shock forging system on both sides; printing, by the 3D printing system, the (N+1)th layer of slice according to the individual design requirements for the internal configurations of the part to be formed; simultaneously, monitoring the internal structure performance, surface performance, shape and dimension of the formed slice layer in real time and on line; feeding back, by the real-time feedback system, data parameters to the 3D printing system and the laser shock forging system in sequence to automatically compensate the relevant process parameters; meanwhile, controlling the laser shock forging system to work synchronously to realize the synchronous coupling action of 3D printing-detection and feedback-laser shock forging;

Step S7: performing data acquisition and error analysis after the synchronous coupling action of 3D printing-detection and feedback-laser shock forging is realized on both sides: acquiring, by the on-line monitoring system, parameters of the internal structure performance, surface performance, shape and dimension of the part to be formed and parameters of four laser beams of the laser device; storing, by the computer, the data and feeding back the data to the 3D printing power adjustment device and the laser shock forging power adjustment device, and performing the error analysis; analytically calculating an optimal thickness N̂ of the slice formed on both sides, and determining whether the thickness of the slice formed on both sides meets the requirement or not;

Step S8: if the synchronous coupling action of 3D printing-detection and feedback-laser shock forging, realized on both sides, meets the relevant requirements, and an error is within an allowable error range, enabling the laser cutting system to work to cut, with laser, the internal configurations such as the cavity, the pipeline and the cold pipe of the part to be formed according to the individual design requirements, or implementing Step S9;

Step S9: comparatively analyzing the relevant, data for automatically compensating the synchronous coupling action of the 3D printing system and the laser shock forging system on the same side and the relevant data for automatically compensating the synchronous coupling action of the 3D printing system and the laser shock forging system on both sides, and selecting the working solution with the best effect; and

Step S10: continuously repeatedly machining the part according to the optimal working solution till the relevant parameters of the internal structure performance, surface performance, shape and dimension of the formed part are close to the desirable requirements and the error is within the allowable error range.

As a preferred solution of the present invention, N is between 8 and 10.

As a preferred solution of the present invention, N̂ is between 8 and 10.

Compared with the prior art, the present invention further has the following advantages that: the laser shock forging light guide system may freely move on both sides of a workpiece; the 3D printing system and the laser shock forging light guide system are distributed on the same side or both sides of the workpiece; the 3D printing system additively manufactures the Nth layer of slice, and the laser shock forging is synchronously performed in the optimal temperature region; the layered contour and the internal complex structures such as the cavity, the pipeline and the cold pipe are cut with laser according to the three-dimensional model of the individual part; the on-line monitoring system monitors the surface performance, shape and dimension of the workpiece; the real-time tracking and feedback system feeds back the data monitored by the on-line monitoring system to the laser beam power adjustment device to automatically compensate the relevant parameters, thereby eliminating the collaborative influence of the 3D printing forming and the synchronous shock forging, improving the surface accuracy of the workpiece and improving the machining efficiency to an extremely large extent. In addition, by cooperation of the computer and the plurality of modules, the error is analyzed for the acquired data to select the optimal working solution to continuously optimize the workpiece until the machining requirements are met.

### DESCRIPTION OF THE DRAWINGS

FIG. 1 is a structural schematic diagram of an embodiment of the present invention when a 3D printing system and a laser shock forging light guide system are located on the same side of a working table;

FIG. 2 is a structural schematic diagram of an embodiment of the present invention when a 3D printing system and a laser shock forging light guide system are located on both sides of a working table; and

FIG. 3 is a working schematic diagram of an embodiment of the present invention.

Numerals in the Drawings:

1: laser shock forging laser head; 2: laser cutting laser head; 3: laser shock forging control system; 4: laser cutting control system; 5: laser cutting power adjustment device; 6: laser shock forging power adjustment device; 7: fourth light guide system; 8: second light guide system; 9: third light guide system; 10: adjustable beam splitter; 11: first power adjustment device; 12: beam splitter; 13: laser device; 14: first light guide system; 15: laser device power adjustment device; 16: computer; 17: 3D printing power adjustment device; 18: powder feeding system; 19: 3D printing control system; 20: powder feeding head; 21: real-time tracking and feedback system; 22: 3D printing head; and 23: on-line monitoring system.

### DETAILED DESCRIPTION OF PREFERRED EMBODIMENTS

In order to make the purposes, technical solutions and advantages of the present invention clearer and more specific, the present invention is further described below with reference to accompanying drawings and embodiments.

Embodiment 1

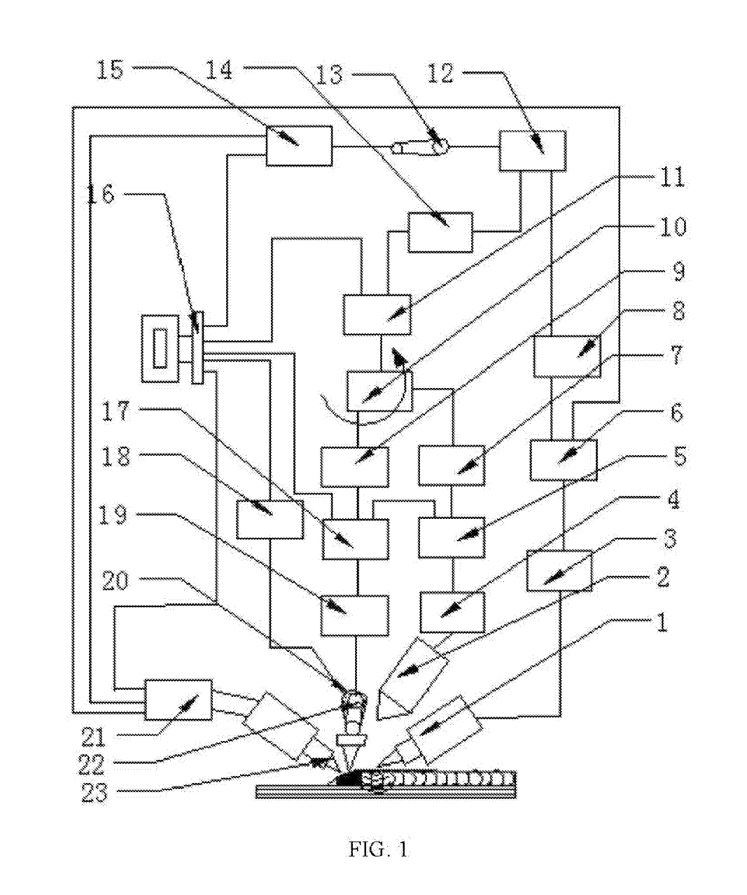

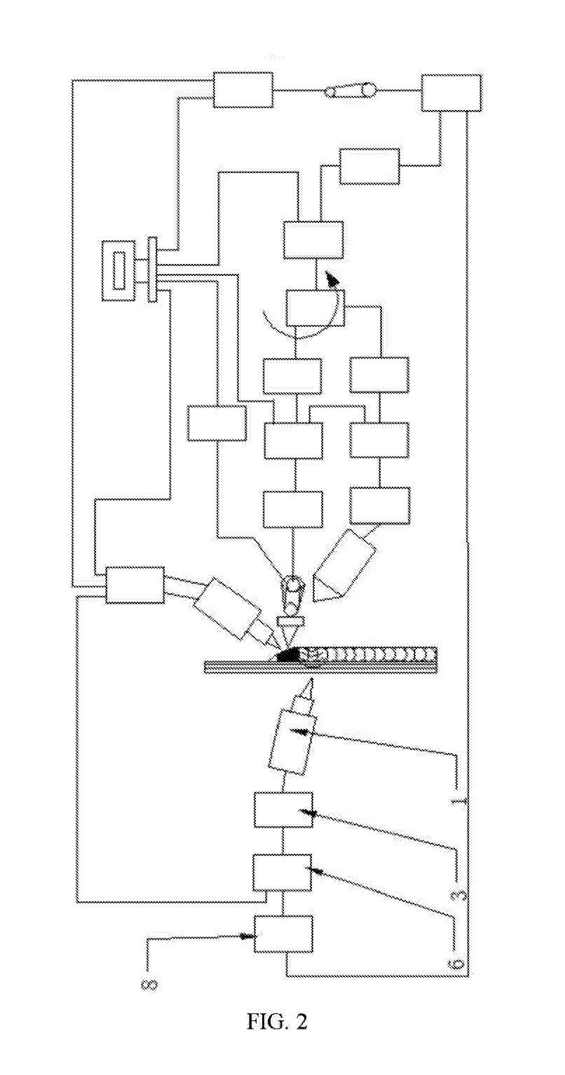

As shown in FIGS. 1, 2 and 3, the present invention discloses a laser shock forging and laser cutting composite additive manufacturing device and method. The manufacturing device mainly includes a laser shock forging control system 3 for controlling a second light guide system 8, a laser shock forging power adjustment device 6 and a laser shock forging laser head 1; a laser cutting control system 4 for controlling a fourth laser beam light guide system 7, a laser cutting power adjustment device 5 and a laser cutting laser head 2; a 3D printing control system 19 for controlling a third laser beam light guide system 9, a 3D printing power adjustment device 17 and a 3D printing head 22; a powder feeding system 18; a powder feeding head 20 for coaxially conveying light and powder; an on-line monitoring system 23 for monitoring the internal structure performance, surface performance, shape and dimension of a part; a real-time tracking and feedback system 21 for feeding back data monitored by the on-line monitoring system 23 to the laser beam power adjustment devices; a power adjustment device 15 for controlling the laser device 13; a beam splitter 12; a first light guide system 14; a first laser beam power adjustment device 11; and an adjustable beam splitter 10 for splitting a first laser beam into a third laser beam and a fourth laser beam. The real-time tracking and feedback system 21, the powder feeding system 18, the 3D printing power adjustment device 17, the first laser beam power adjustment device 11 and the power adjustment device 15 are connected with the computer 16 and are controlled by the computer 16.

The laser shock forging light guide system 3 may freely move on both sides of the working table. The 3D printing system 20 and the laser shock forging system 1 synchronously work on the same side: spacing distances from the on-line monitoring system 23 to the 3D printing system 20 and the laser shock forging system 1 are obtained by blending analysis of corresponding temperature fields of the 3D printing and the shock forging to realize a synchronous action of the three systems. The 3D printing system 20 and the laser shock forging system 1 may be distributed at corresponding portions of both sides of a blade and work synchronously: the 3D printing system 20 and the laser shock forging system 1 are symmetrically distributed along a center line, and the on-line monitoring system and the 3D printing system are distributed in a certain spacing, and also may independently rotate to the laser shock forging side to achieve the synchronization action of the three systems. An optimal working solution is selected through error analysis to improve the machining efficiency.

The 3D printing system 3, the laser shock forging system 2 and the laser cutting system 4 may enable the laser beam light guide systems of the laser device to select different parameters according to different requirements in the machining technological process. The on-line monitoring system 23 is used to synchronously detect a formed part, and the real-time tracking and feedback system 21 adjusts information and parameters such as the internal structure performance, surface performance, shape and dimension of the part and transmits the information and parameters to the laser beam power adjustment devices to respectively adjust and control relevant parameters of laser beams. After the relevant parameters are automatically compensated, the part is machined repeatedly for multiple times.

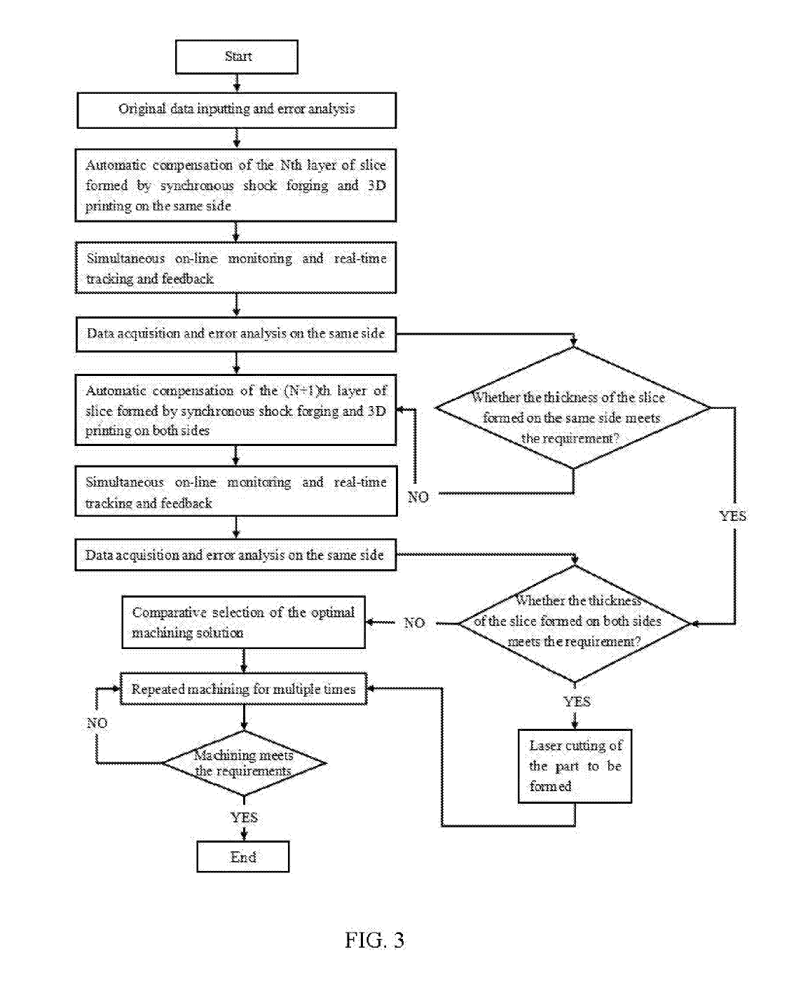

As shown in FIG. 3, the present invention discloses a laser shock forging and laser cutting composite additive manufacturing method. The method specifically includes the following working steps:

(1) original data are input:

a three-dimensional model of a part to be formed is designed according to individual design requirements, for example: internal configurations such as a cavity, a pipeline and a cold pipe of the formed part; layer-by-layer slicing treatment is performed to determine an optimal number of layers suitable for laser cutting; main process parameters of 3D printing are calculated and then optimized; main process parameters of laser shock forging are estimated and then optimized; an optimal temperature region for the laser shock forging is determined; relevant data are transmitted into a computer as the original data which are used as an adjustment control standard for relevant parameters of a laser shock forging and laser cutting composite additive manufacturing process;

(2) error analysis is performed;

a first layer of slice is formed through laser 3D printing, and the laser shock forging is synchronously performed in the optimal temperature region; when the Nth layer of slice is obtained (N is generally equal to 8 to 10), laser cutting is performed on the part to obtain a layered contour and internal complex structures; an on-line monitoring system 23 monitors whether the internal structure performance, surface performance, shape and dimension of the part meet desirable requirements or not; the original data in Step 1 are comparatively analyzed to determine whether the relevant process parameters are correct or not; the error analysis is performed to automatically compensate the process parameters and determine final optimal process parameters;

(3) the Nth layer of slice formed by synchronous shock forging and 3D printing is automatically compensated on the same side:

a 3D printing system 3 and a laser shock forging system 2 are installed on the same side of a working table; the 3D printing system prints the Nth layer of slice according to the individual design requirements for the internal configurations such as the cavity, the pipeline and the cold pipe of the part to be formed; the internal structure performance, surface performance, shape and dimension of the formed slice layer are monitored in real time and on line; a real-time feedback system 21 feeds back data parameters to the 3D printing system 3 and the laser shock forging system 2 in sequence to automatically compensate the relevant process parameters; meanwhile, a second laser beam control system controls the laser shock forging system to work synchronously to realize a synchronous coupling action of 3D printing-detection and feedback-laser shock forging;

(4) data acquisition and error analysis are performed after the synchronous coupling action of 3D printing-detection and feedback-laser shock forging is realized on the same side:

the on-line monitoring system 23 acquires parameters of the internal structure performance, surface performance, shape and dimension of the part to be formed and parameters of four laser beams of a laser device; a computer stores the data and feeds back the data to a third laser beam power adjustment device and a second laser beam power adjustment device, and performs the error analysis; an optimal thickness N (N is generally equal to 8 to 10) of the slice formed on the same side is analytically calculated, and whether the thickness of the slice formed on both sides meets the requirement or not is determined;

(5) if the synchronous coupling action of 3D printing-detection and feedback-laser shock forging, realized on the same side, meets the relevant requirements, and an error is within an allowable error range, a laser cutting system 4 works to cut, with laser, the internal configurations such as the cavity, the pipeline and the cold pipe of the part to be formed according to the individual design requirements, or Step (6) is implemented;

(6) the (N+1)th layer of slice formed by synchronous shock forging and 3D printing is automatically compensated on both sides:

the 3D printing system and the laser shock forging system are distributed on both sides; the 3D printing system prints the (N+1)th layer of slice according to the individual design requirements for the internal configurations such as the cavity, the pipeline and the cold pipe of the part to be formed; the internal structure performance, surface performance, shape and dimension of the formed slice layer are monitored in real time and on line; the real-time feedback system, feeds back data parameters to the 3D printing system 3 and the laser shock forging system 2 in sequence to automatically compensate the relevant process parameters; meanwhile, the second laser beam control system controls the laser shock forging system 2 to work synchronously to realize the synchronous coupling action of 3D printing-detection and feedback-laser shock forging;

(7) data acquisition and error analysis are performed after the synchronous coupling action of 3D printing-detection and feedback-laser shock forging is realized on both sides:

the on-line monitoring system acquires parameters of the internal structure performance, surface performance, shape and dimension of the part to be formed and parameters of four laser beams of the laser device; the computer stores the data and feeds back the data to the third laser beam power adjustment device and the second laser beam power adjustment device, and performs the error analysis; an optimal thickness N̂ (N̂ is generally equal to 8 to 10) of the slice formed on both sides is analytically calculated, and whether the thickness of the slice formed on both sides meets the requirement or not is determined;

(8) if the synchronous coupling action of 3D printing-detection and feedback-laser shock forging, realized on both sides, meets the relevant requirements, and an error is within an allowable error range, the laser cutting system works to cut, with laser, the internal configurations such as the cavity, the pipeline and the cold pipe of the part to be formed according to the individual design requirements, or Step (9) is implemented;

(9) the relevant data for automatically compensating the synchronous coupling action of the 3D printing system and the laser shock forging system on the same side and the relevant data for automatically compensating the synchronous coupling action of the 3D printing system and the laser, shock forging system on both sides are comparatively analyzed, and the working solution with the best effect is selected; and

(10) the part is continuously repeatedly machined according to the optimal working solution till the relevant parameters of the internal structure performance, surface performance, shape and dimension of the formed part are close to the desirable requirements and the error is within the allowable error range.

In this solution, the laser shock forging light guide system 2 may freely move on both sides of a workpiece; the 3D printing system 3 and the laser shock forging light guide system 2 are distributed on the same side or both sides of the workpiece; the 3D printing system additively manufactures the Nth layer of slice, and the laser shock forging is synchronously performed in the optimal temperature region; the layered contour and the internal complex structures such as the cavity; the pipeline and the cold pipe are cut with laser according to the three-dimensional model of the individual part; the on-line monitoring system 23 monitors the surface performance, shape and dimension of the workpiece; the real-time tracking and feedback system 21 feeds back the data monitored by the on-line monitoring system to the laser beam power adjustment device to automatically compensate the relevant parameters, thereby eliminating the collaborative influence of the 3D printing forming and the synchronous shock forging, improving the surface accuracy of the workpiece and improving the machining efficiency to an extremely large extent. In addition, by cooperation of the computer 16 and the plurality of modules, the error is analyzed for the acquired data to select the optimal working solution to continuously optimize the workpiece until the machining requirements are met or to select the optimal working solution to continuously optimize the formed part until the machining requirements are met.

The above embodiments are preferred implementation modes of the present invention, but the implementation modes of the present invention are not limited by the above embodiments. Any other changes, modifications, substitutions, combination and simplifications that are made without departing from the spiritual essence and principle of the present invention shall be equivalent replacements and fall within the protection scope of the present invention.

We claim:

1. A laser shock forging and laser cutting composite additive manufacturing device, comprising a laser generating system used for generating and controlling a laser beam, a laser shock forging system, a 3D (3-Dimensional) printing system, a laser cutting system, an on-line monitoring system used for monitoring internal structure performance, surface performance, shape and dimension of a part; and a real-time tracking and feedback system used for feeding back data to a plurality of laser beam power adjustment devices, wherein the laser generating system is respectively connected with the laser shock forging system, the 3D printing system, the laser cutting system and the real-time tracking and feedback system; the on-line monitoring system is connected with the real-time tracking and feedback system;
the laser generating system comprises a computer, a laser device, a laser device power adjustment device, a beam splitter for splitting the laser beam into a first laser beam and a second laser beam, a first light guide system for controlling the first laser beam, a first power adjustment device and an adjustable beam splitter for splitting the first laser beam into a third laser beam and a fourth laser beam; the computer, the laser device power adjustment device, the laser device and the beam splitter are connected in sequence; one end of the first power adjustment device is connected with the first light guide system, and the other end of the first power adjustment device is connected with the adjustable beam splitter; the laser shock forging system comprises a second light guide system for controlling the second laser beam, a laser shock forging power adjustment device, a laser shock forging laser head and a laser shock forging control system; the second light guide system, the laser shock forging power adjustment device, the laser shock forging control system and the laser shock forging laser head are connected in sequence; the second light guide system is connected with the beam splitter; the laser cutting system comprises a fourth light guide system for controlling the fourth laser beam, a laser cutting power adjustment device, a laser cutting laser head and a laser cutting control system; the fourth light guide system, the laser cutting power adjustment device, the laser cutting control system and the laser cutting laser head are connected in sequence; the fourth light guide system is connected with the adjustable beam splitter; the 3D printing system comprises a third light guide system for controlling the third laser beam, a 3D printing power adjustment device, a 3D printing head, a powder feeding system, a powder feeding head for coaxially conveying light and powder and a 3D printing control system; the third light guide system, the 3D printing power adjustment device, the 3D printing control system and the 3D printing head are connected in sequence;
the powder feeding head is mounted on the 3D printing head and is connected with the computer through the powder feeding system; the third light guide system is connected with the beam splitter; and the real-time tracking and feedback system is respectively connected with the computer, the laser power adjustment device, the first power adjustment device, the laser shock forging power adjustment device, the laser cutting power adjustment device and the 3D printing power adjustment device.

2. The laser shock forging and laser cutting composite additive manufacturing device according to claim 1, wherein the laser cutting laser head and the 3D printing head are disposed adjacently and in parallel; and the adjustable beam splitter respectively controls the laser cutting laser head and the 3D printing head to work simultaneously or independently.

3. The laser shock forging and laser cutting composite additive manufacturing device according to claim 2, wherein the laser shock forging system is disposed on the same side with the laser cutting laser head and the 3D printing head or on the side opposite to the laser cutting laser head and the 3D printing head, and the laser shock forging system may freely move on a working table.

4. The laser shock forging and laser cutting composite additive manufacturing device according to claim 1, wherein the laser cutting system may act on one or more slice layers.

5. A laser shock forging and laser cutting composite additive manufacturing method, comprising the following steps:
Step S1: inputting original data: designing a three-dimensional model of a part to be formed according to individual design requirements, performing layer-by-layer slicing treatment to determine an optimal number of layers suitable for laser cutting, calculating main process parameters of 3D printing and optimizing the parameters, estimating main process parameters of laser shock forging and optimizing the parameters, and determining an optimal temperature region for the laser shock forging; transmitting relevant data into a computer as the original data which are used as an adjustment control standard for relevant parameters of a laser shock forging and laser cutting composite additive manufacturing process;
Step S2: performing error analysis: forming a first layer of slice through laser 3D printing and synchronously, performing synchronous laser shock forging in the optimal temperature region; when the Nth layer of slice is obtained, performing laser cutting on the part to obtain a layered contour and internal complex structures;
monitoring, by an on-line monitoring system, whether the internal structure performance, surface performance, shape and dimension of the part meet desirable requirements or not, comparatively analyzing the original data in Step 1 to determine whether the relevant process parameters are correct or not, and performing the error analysis to automatically compensate the process parameters and determine final optimal process parameters;
Step S3: automatically compensating the Nth layer of slice formed by synchronous shock forging and 3D printing on the same side: installing a 3D printing system and a laser shock forging system on the same side of a working table; printing, by the 3D, printing system, the Nth layer of slice according to the individual design requirements for internal configurations such as a cavity, a pipeline and a cold pipe of the part to be formed; simultaneously; monitoring the internal structure performance, surface performance, shape and dimension of the formed slice layer in real time and on line; feeding back, by a real-time feedback system, data parameters to the 3D printing system and the laser shock forging system in sequence to automatically compensate the relevant process parameters; meanwhile, controlling, by a second laser beam control system, the laser shock forging system to work synchronously to realize a synchronous coupling action of 3D printing-detection and feedback-laser shock forging;
Step 4: performing data acquisition and error analysis after the synchronous coupling action of 3D printing-detection and feedback-laser shock forging is realized on the same side: acquiring, by the on-line monitoring system, parameters of the internal structure performance, surface performance, shape and dimension of the part to be formed and parameters of four laser beams of a laser device; storing, by a computer, the data and feeding back the data to a 3D printing power adjustment device and a laser shock forging power adjustment device, and performing the error analysis;
analytically calculating an optimal thickness N of the slice formed on the same side, and determining whether the thickness of the slice formed on both sides meets the requirement or not;
Step S5: if the synchronous coupling action of 3D printing-detection and feedback-laser shock forging, realized on the same side, meets the relevant requirements, and an error is within an allowable error range, enabling a laser cutting system to work to cut, with laser, the internal configurations such as the cavity, the pipeline and the cold pipe of the part to be formed according to the individual design requirements, or implementing Step S6;
Step S6: automatically compensating the (N+1)th layer of slice formed by synchronous shock forging and 3D printing on both sides: distributing the 3D printing system and the laser shock forging system on both sides; printing, by the 3D printing system, the (N+1)th layer of slice according to the individual design requirements for the internal configurations of the part to be formed; simultaneously, monitoring the internal structure performance, surface performance, shape and dimension of the formed slice layer in real time and on line; feeding back, by the real-time feedback system, data parameters to the 3D printing system and the laser shock forging system in sequence to automatically compensate the relevant process parameters; meanwhile, controlling the laser shock forging system to work synchronously to realize the synchronous coupling action of 3D printing-detection and feedback-laser shock forging;
Step S7: performing data acquisition and error analysis after the synchronous coupling action of 3D printing-detection and feedback-laser shock forging is realized on both sides: acquiring, by the on-line monitoring system, parameters of the internal structure performance, surface performance, shape and dimension of the part to be formed and parameters of four laser beams of the laser device; storing, by the computer, the data and feeding back the data to the 3D printing power adjustment device and the laser shock forging power adjustment device, and performing the error analysis; analytically calculating an optimal thickness N̂ of the slice formed on both sides, and determining whether the thickness of the slice formed on both sides meets the requirement or not;
Step S8: if the synchronous coupling action of 3D printing-detection and feedback-laser shock forging, realized on both sides, meets the relevant requirements, and an error is within an allowable error range, enabling the laser cutting system to work to cut, with laser, the internal configurations such as the cavity, the pipeline and the cold pipe of the part to be formed according to the individual design requirements, or implementing Step S9;
Step S9: comparatively analyzing the relevant data for automatically compensating the synchronous coupling action of the 3D printing system and the laser shock forging system on the same side and the relevant data for automatically compensating the synchronous coupling action of the 3D printing system and the laser shock forging system on both sides, and selecting the working solution with the best effect; and
Step S10: continuously repeatedly machining the part according to the optimal working solution till the relevant parameters of the internal structure performance, surface performance, shape and dimension of the formed part are close to the desirable requirements and the error is within the allowable error range.
